(19) United States
(12) Patent Application Publication
(10) Pub. No.: US 2013/0308292 A1
(43) Pub. Date: Nov. 21, 2013

(54) LED LAMP

(71) Applicants: Ming-Te LIN, New Taipei City (TW); Ming-Yao LIN, New Taipei City (TW); Heng QIU, New Taipei City (TW)

(72) Inventors: Ming-Te LIN, New Taipei City (TW); Ming-Yao LIN, New Taipei City (TW); Heng QIU, New Taipei City (TW)

(73) Assignee: UNILED LIGHTING TAIWAN INC., New Taipei City (TW)

(21) Appl. No.: 13/474,793

(22) Filed: May 18, 2012

(51) Int. Cl. F21V 9/16; F21V 9/00; F21V 13/02; F21V 8/00

(52) U.S. Cl. 362/84; 362/317; 362/343; 362/256; 362/257; 362/296.01; 427/157

(57) ABSTRACT

The present invention discloses an LED lamp which has a light guide with a total internal reflection (TIR) surface. A light modification layer comprising either a pure component or a mixture of the component selected from a group consisted of a yellow phosphor, a red phosphor, a green phosphor, a blue phosphor, and a reflective material is optionally adopted. The light beam is modified by the light modification layer before going out of the lamp. A blue light is one of the candidates which can be adopted as the light source.

### BACKGROUND

1. Technical Field

The present invention relates to an LED lamp, especially a lamp with a light guide having a total internal reflection surface. Further, the lamp is optionally to adopt a light modification layer comprising either a pure component or a mixture of the component selected from a group consisted of a yellow phosphor, a red phosphor, a green phosphor, a blue phosphor, and a reflective material. The light beam is modified by the light modification layer before going out of the lamp.

2. Description of Related Art

FIG. 1 is a prior art

FIG. 1 illustrates a cross-sectional structure for a conventional LED lamp 20. The LED lamp 20 includes an LED chip 21, a bullet-shaped transparent housing to cover the LED chip 21. The leads 22a and 22b supply current to the LED chip 21. A cup reflector 23 for reflecting the emission of the LED chip 21 is configured on a top of the lead 22b. The inner walls of the cup reflector 23 surround the side surfaces of the LED chip 21. The LED chip 21 is encapsulated with a first resin portion 24, which is further encapsulated with a second resin portion 25. A phosphor 26 is dispersed in the first resin portion 24 so as to be excited with the light emitted from the LED chip 21. The conventional LED lamp has a low power efficiency and color unevenness problem.

### BRIEF DESCRIPTION OF THE DRAWINGS

FIG. 1 is a prior art.

FIGS. 2A˜2B is a first embodiment of the present invention

FIGS. 3A˜3C is the operation with a light modification layer of the first embodiment.

FIGS. 4A˜6B are several embodiments of the light modification layer.

FIG. 7 is a lamp equipped with the first embodiment.

FIG. 8A˜8C is an exploded view of a second embodiment of the present invention.

FIG. 9 shows a lamp combination of the components of FIG. 8A.

FIG. 10A˜10B shows a third embodiment of the present invention.

FIG. 11A˜11C is a fourth embodiment of the present invention.

FIG. 12A˜12B is a modification version of the third embodiment.

FIG. 13 is a lamp equipped with the third embodiment.

FIG. 14 is a fourth embodiment of the present invention.

FIG. 15A˜15C is a section view of the fourth embodiment.

FIG. 16A˜16C a modification embodiment to the embodiment of FIG. 2B.

FIG. 17A˜17B a modification embodiment to the embodiment of FIG. 8A.

FIG. 18A˜18C a modification embodiment to the embodiment of FIG. 11A.

FIG. 19 is a method for preparation of the modification layer of the present invention.

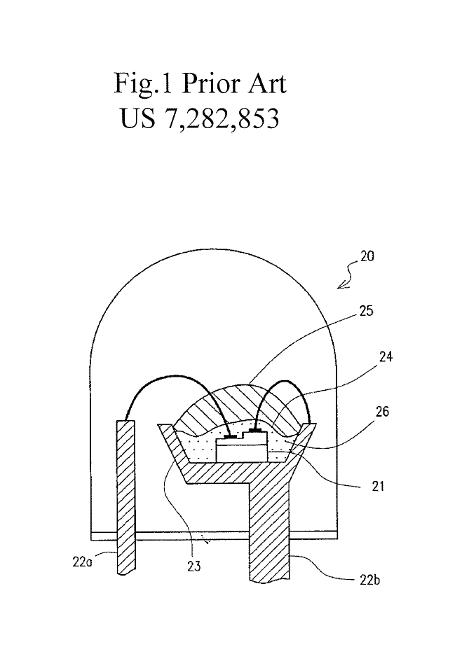

### DETAILED DESCRIPTION OF THE INVENTION

This invention discloses an LED equipped with a light guide which has a TIR surface. Further, a light modification layer is optionally adopted for modifying the light beam before it exits the lamp.

A blue light excited phosphor is capable of absorbing blue light to emit a longer wavelength light. A reflective material is capable of reflecting the original blue light. The choices for the phosphor is one or a mixture of the ones selected from the group consisted of blue excited yellow phosphor, blue excited red phosphor, and blue excited green phosphor. The choices for the reflective materials can be one or a mixture of the ones selected from the group consisted of BaSO4, MgO, TiO2, and zinc sulfide-barium pigment.

For a light source to be a blue light, different light modification is exemplified as follows:

A combination of a blue light, yellow phosphor, and reflective materials, gives off yellow light plus blue light to create a white light with a correlated color temperature (CCT) ranging from 5000K to 6500K with a color rending index (CRI) ranging from 60 to 75.

A combination of a blue light, yellow phosphor, red phosphor, and reflective materials, gives off yellow light, red light plus blue light to create a warm white light (or a low white light) with a correlated color temperature (CCT) ranging from 2500K to 3000K with a Color rendering index (CRI) ranging from 75 to 85.

A combination of a blue light, yellow phosphor, red phosphor, green phosphor, red phosphor, and reflective materials, gives off yellow light, red light, green light plus blue light to create a white light with a color rendering index (CRI) ranging from 80 to 99.

A combination of a blue light, red phosphor, and reflective materials, gives off a purple light.

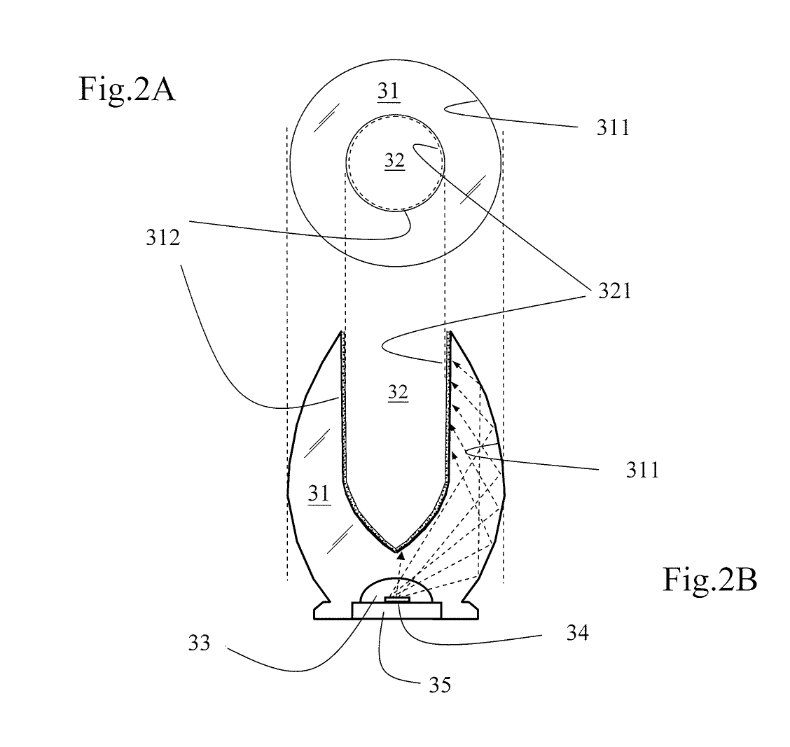

FIGS. 2A˜2B is a first embodiment of the present invention

FIG. 2A is a top view of the first embodiment of the present invention. FIG. 2A discloses a lamp which has a light guide 31. The light guide 31 has a peripheral boundary surface 311, and an inner boundary surface 312. A longitudinal hole 32 is configured in a center of the light guide 31. A light modification layer 321 is coated on the external surface of the inner boundary surface 312, i.e. the wall surface of the longitudinal hole 32. The peripheral boundary surface 311 is made a total internal reflective (TIR) surface.

FIG. 2B is a section view of the first embodiment. A bottom cup recess 33 has an open downward. An LED 34 is housed in the recess 33. The LED 34 is mounted on a base 35. The base is either a substrate for adjusting the height of the LED 34 or a circuit board having circuit thereon for controlling the LED 34. A light modification layer 321 is coated on a wall surface of the longitudinal hole 32. The light beam emitted from the LED 34 is first reflected by the TIR surface 311 and then impinges onto the light modification layer 321. The modified light beam passes the light guide 31 and the TIR surface 311 before going out of the light guide 31.

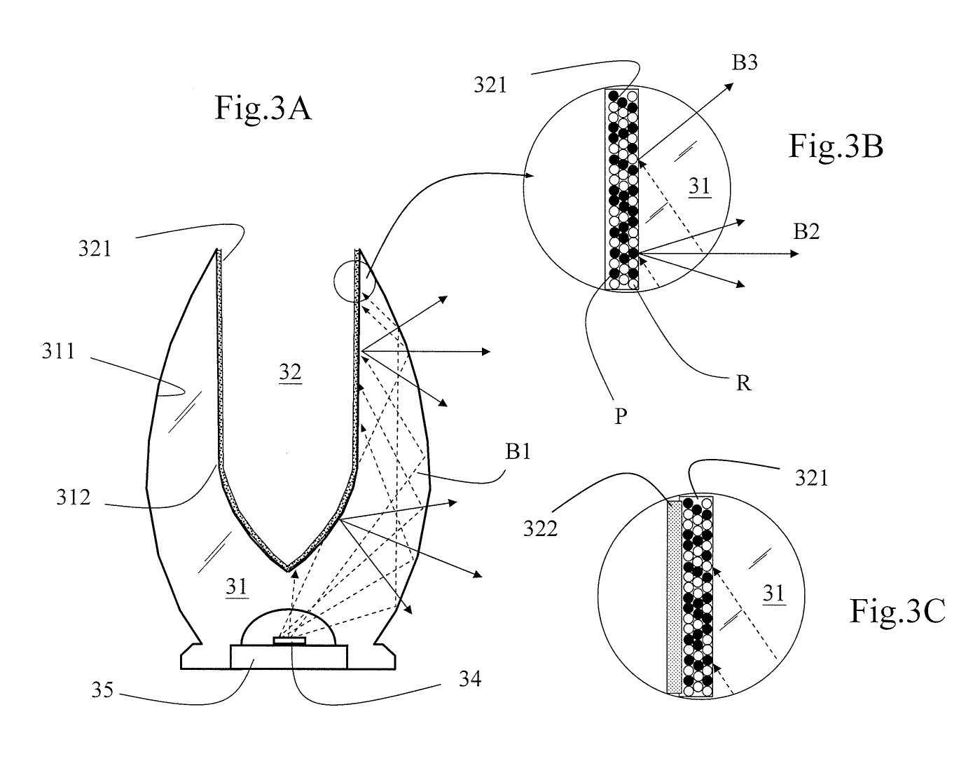

FIGS. 3A˜3C is the operation with a light modification layer of the first embodiment.

FIG. 3A shows a light modification layer 321 is coated on the wall surface of the longitudinal hole 32. The light modification layer 321 is a compact aggregation of a powder.

For the cases where a blue light source is used, the powder is one or a combination of ones selected from a group consisted of a yellow phosphor, a red phosphor, and green phosphor, and a reflective material.

FIG. 3B shows one of the examples, a compact aggregation of a powder mixture of phosphor P and a reflective material R. For example, when a blue chip 34 is used as a light source, the blue light B1 is first reflected by the TIR surface 311 and then impinges the light modification layer 321. The phosphor P absorbs the blue light to emit a longer wavelength light beam B2 which then passes through the light guide 31 and the TIR surface 311 before going out of the light guide 31. The reflective material R reflects the blue light, the reflected blue light beam B3 then passes the light guide 31 and the TIR surface 311 before going out of the light guide 31. The longer wavelength light beam B2 is visually mixed with the light beam B3 to exit the light guide.

The yellow phosphor is capable of absorbing a short wavelength light to emit a yellow light. The red phosphor is capable of absorbing a short wavelength light to emit red light. The green phosphor is capable of absorbing a short wavelength light to emit green light. The blue phosphor is capable of absorbing a short wavelength light to emit blue light.

The reflective material is capable of reflecting the visible light emitted from the light source 34 such as blue light. The reflective material is one or a combination of ones selected from the group consisted of BaSO4, MgO, TiO2, and zinc sulfide-barium pigment.

FIG. 3C shows a modification embodiment to FIG. 3B, a reflection layer 322 is further coated on an outer surface of the light modification layer 321 to enhance the reflection of the light beams.

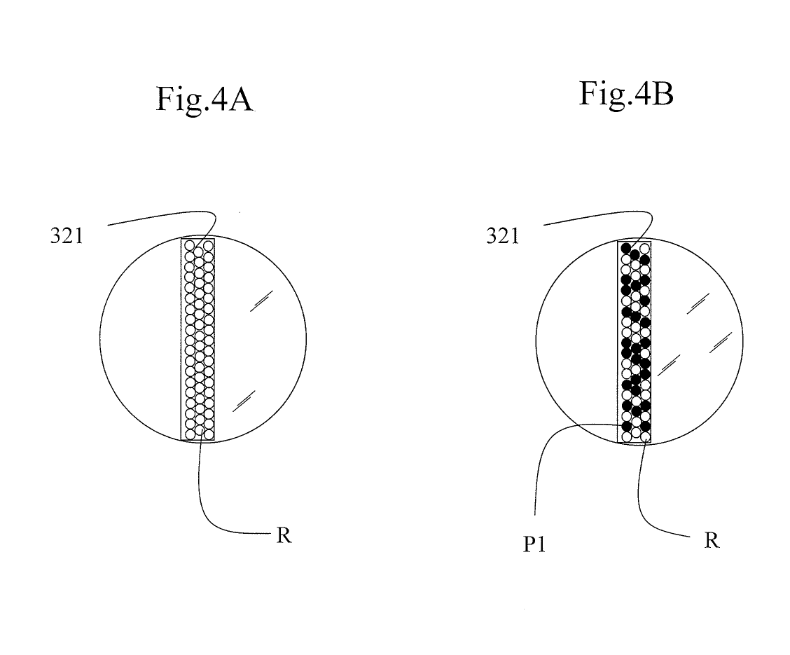

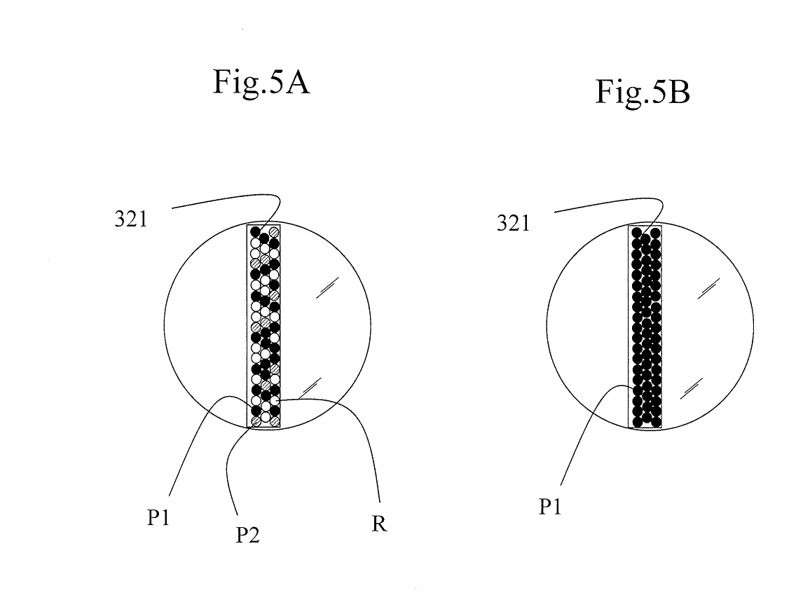

FIGS. 4A˜6B are several embodiments of the light modification layer.

FIG. 4A shows a first embodiment of the light modification layer 321 where a pure reflective material R is used. FIG. 4B shows a second embodiment of the light modification layer 321 where a mixture of a reflective material R and a phosphor P1 is used. FIG. 5A shows a third embodiment of the light modification layer where a mixture of a reflective material R, a phosphor P1, and a second phosphor P2 is used. FIG. 5B shows a fourth embodiment of the light modification layer where a pure phosphor P1 is used. FIG. 6A shows a fifth embodiment of the light modification layer where a mixture of a first phosphor P1 and a second phosphor P2 is used. FIG. 6B shows a sixth embodiment of the light modification layer where a mixture of a first phosphor P1, a second phosphor P2, and a third phosphor P3 is used.

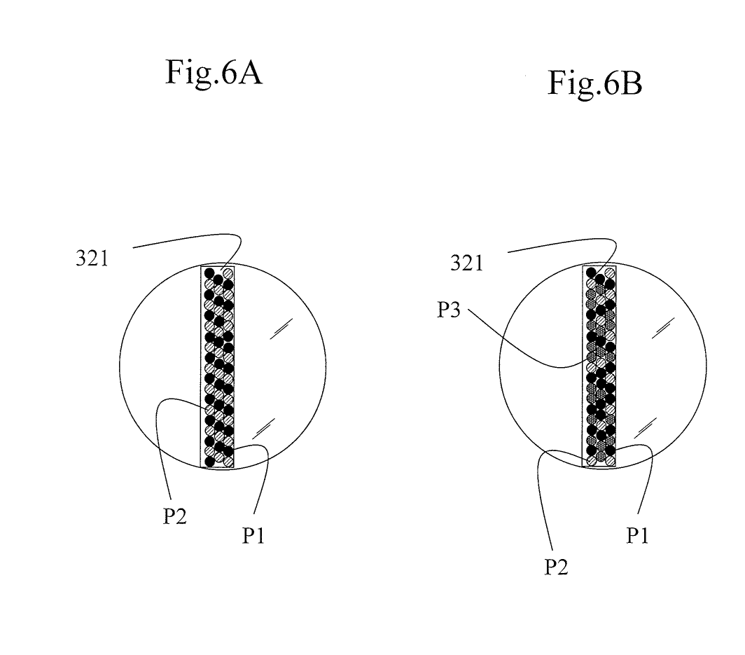

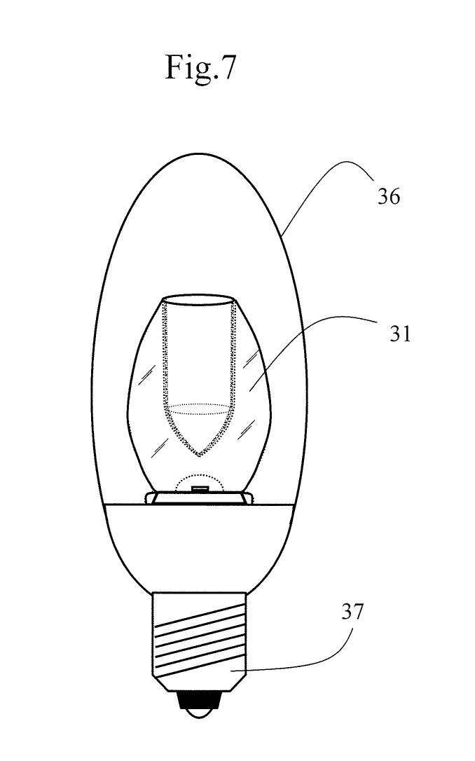

FIG. 7 is a lamp equipped with the first embodiment.

FIG. 7 shows a protection envelope 36 encloses the light guide 31 to prevent water or dust attaching to the light guide 31. A lamp base 37 is configured on a bottom of the protection envelope 36 such that the lamp is capable of mounting into a traditional lamp socket.

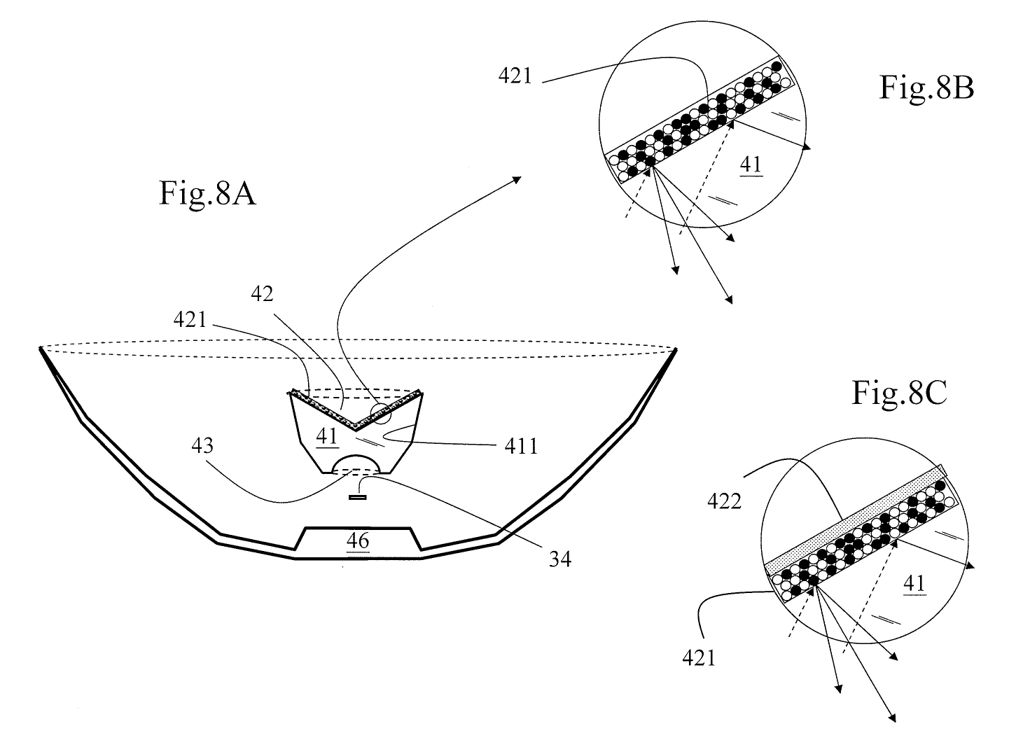

FIG. 8A˜8C is an exploded view of a second embodiment of the present invention.

FIG. 8A shows that the components of a lamp are prepared, which includes a light guide 41 having a conical recess 42 on top. The light guide 41 has a peripheral boundary surface 411 which is made a total internal reflection (TIR) surface 411. A bottom cup recess 43 is configured on the bottom of the light guide 41. A chip 34 and a reflective cup 46 are also prepared. FIG. 8B shows a light modification layer 421 is coated on the top surface of the conical recess 42. The light chip 34 is housed in the bottom cup recess 43. FIG. 8C shows a modification embodiment to FIG. 8B, a reflection layer 422 is coated on an outer surface of the light modification layer 421 to enhance the reflection of the light beams.

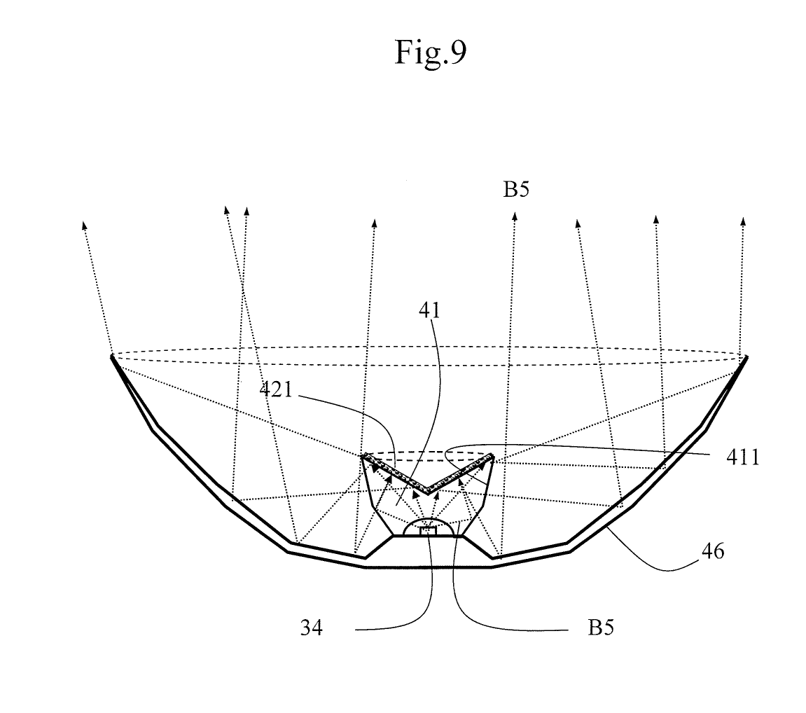

FIG. 9 shows a lamp combination of the components of FIG. 8A.

The light beams B5 from the light chip 34 is first reflected by the TIR surface 411, then modified by the light modification layer 421. Then the modified light beam B5 passes the light guide 41 and the TIR surface 411 before going out of the light guide 41. The reflection cup 46 collects the light beams B5 from the light guide 41 to reflect it upward as shown in the figure.

The components and the function of the light modification layer in this embodiment is the same as that in the former embodiment. The light modification layer 421 is a compact aggregation of a powder. The powder is one or a combination of ones selected from a group consisted of a yellow phosphor, a red phosphor, and green phosphor, and blue phosphor, and a reflective material.

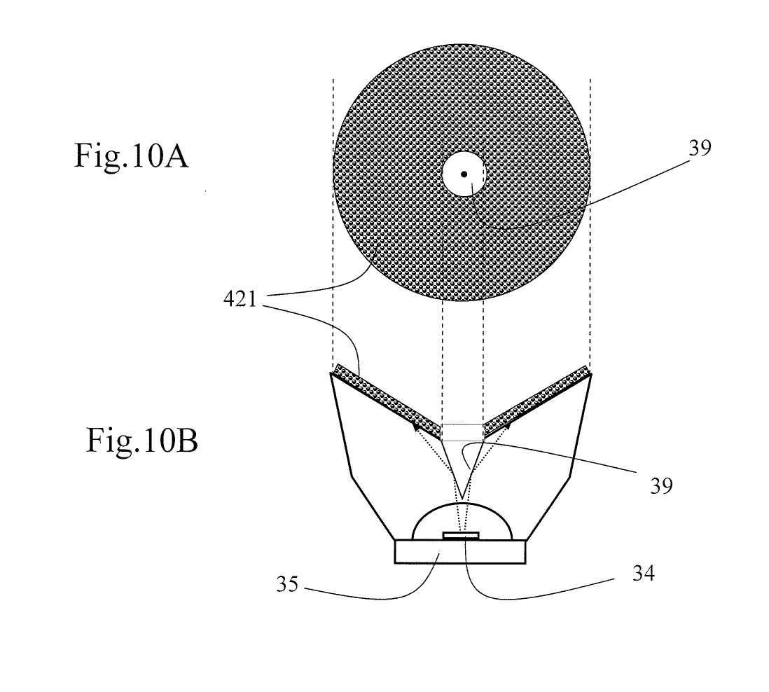

FIG. 10A˜10B shows a third embodiment of the present invention.

FIG. 10A is a top view of FIG. 10B. FIG. 10A shows a further conical recess 39 is made on bottom of the first conical recess as shown in FIG. 9. The wall of the further conical recess 39 is made a TIR surface to collect and reflect more light beams from the center of the light chip 34. The further conical recess 39 has a smaller fan angle than the fan angle of the first conical recess on top.

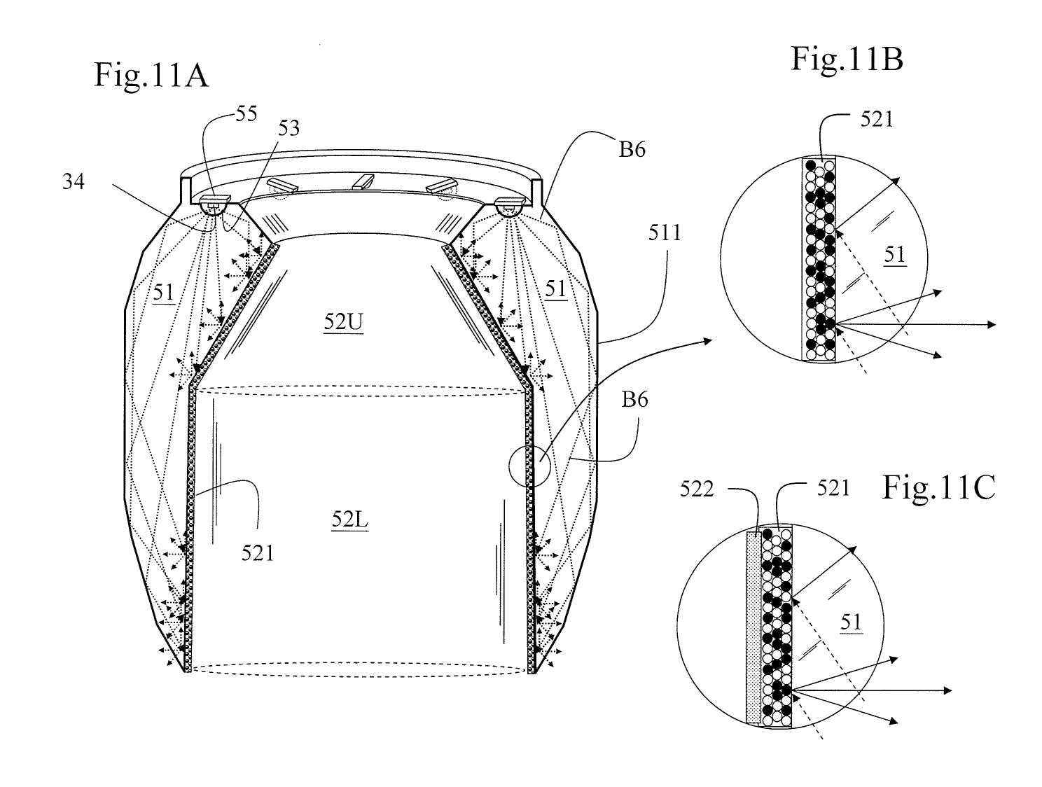

FIG. 11A˜11C is a fourth embodiment of the present invention.

FIG. 11A shows a light guide 51 which has a TIR surface 511, configured in an outer periphery of the light guide 51. A longitudinal through channel 52 is configured in a center of the light guide 51. An upper portion 52U of the channel 52 is tapered out downward. A lower portion 52L of the channel 52 is in a shape of a tube. A light modification layer 521 is coated on the wall surface of the longitudinal through channel 52.

A plurality of top cup recess 53 evenly distributes on a top of the light guide 51. A light chip 34, mounted on a base 55, is suspended on a top center of the top cup recess 53. FIG. 10B shows the light beam B6 is first reflected by the TIR surface 511, then modified by the light modification layer 521. The modified light beam passes through the light guide 51 and the TIR surface 511 before going out of the light guide 51. The light modification layer 521 is a compact aggregation of a powder. The powder is one or a combination of ones selected from a group consisted of a yellow phosphor, a red phosphor, and green phosphor, and blue phosphor, and a reflective material.

FIG. 11C shows a modification embodiment to FIG. 11B, a reflection layer 522 is coated on an outer surface of the light modification layer 521 to enhance the reflection of the light beams.

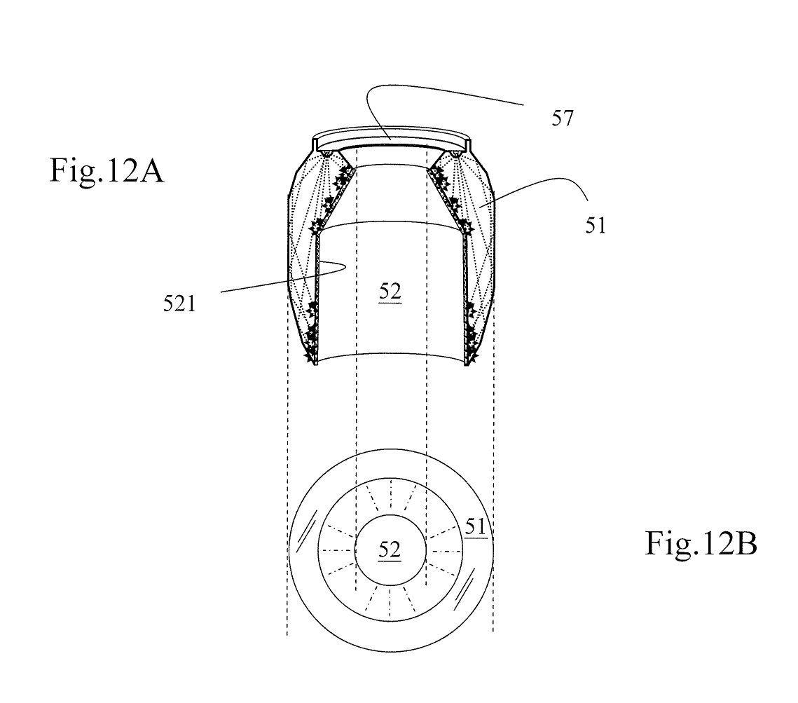

FIG. 12A˜12B is a modification version of the third embodiment.

FIG. 12A shows a ring-shape circuit board 57 is configured on a top of the guide 51 for mounting the light chip 34 there under. FIG. 12B shows a bottom view of the light guide 51, a longitudinal through channel 52 is configured in the center of the light guide 51.

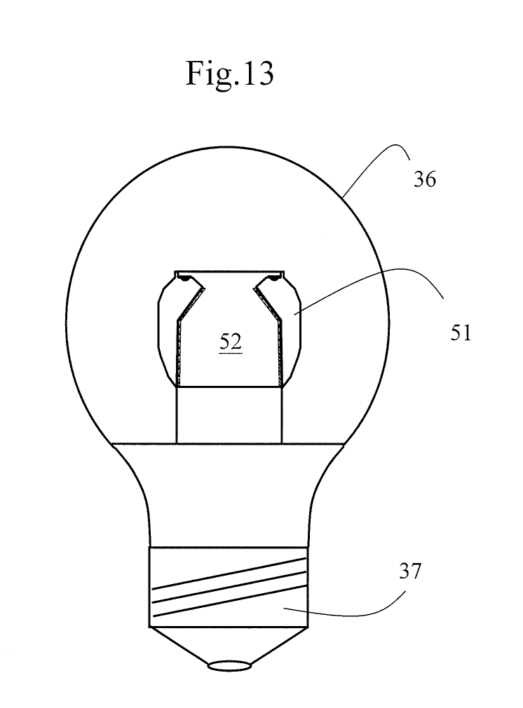

FIG. 13 is a lamp equipped with the third embodiment.

FIG. 13 shows a protection envelope 36 enclosing the light guide 51 to prevent water or dust from entering the light guide 51. A lamp base 37 is configured on a bottom of the protection envelope 36.

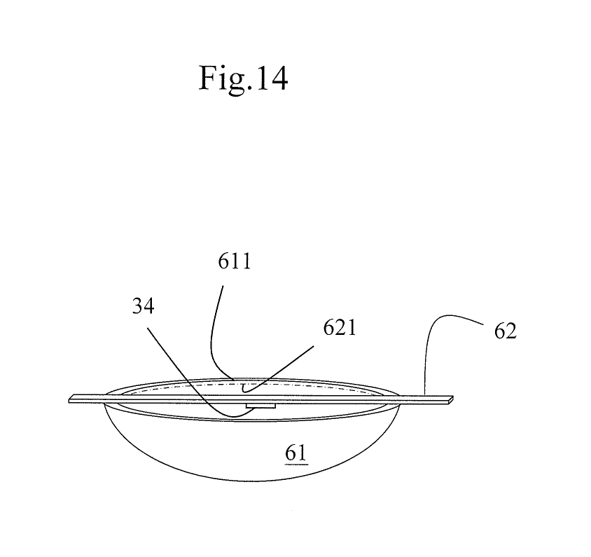

FIG. 14 is a fourth embodiment of the present invention.

FIG. 14 shows a cup lamp which has a cup 61 with an inner surface 611. A latitudinal beam 62 is configured on a top of the cup 61. A light modification layer 621 is coated on the inner surface 611. A light chip 34 is mounted on a bottom surface of the latitudinal beam 62. The light chip 34 is suspended on a center top of the cup 61.

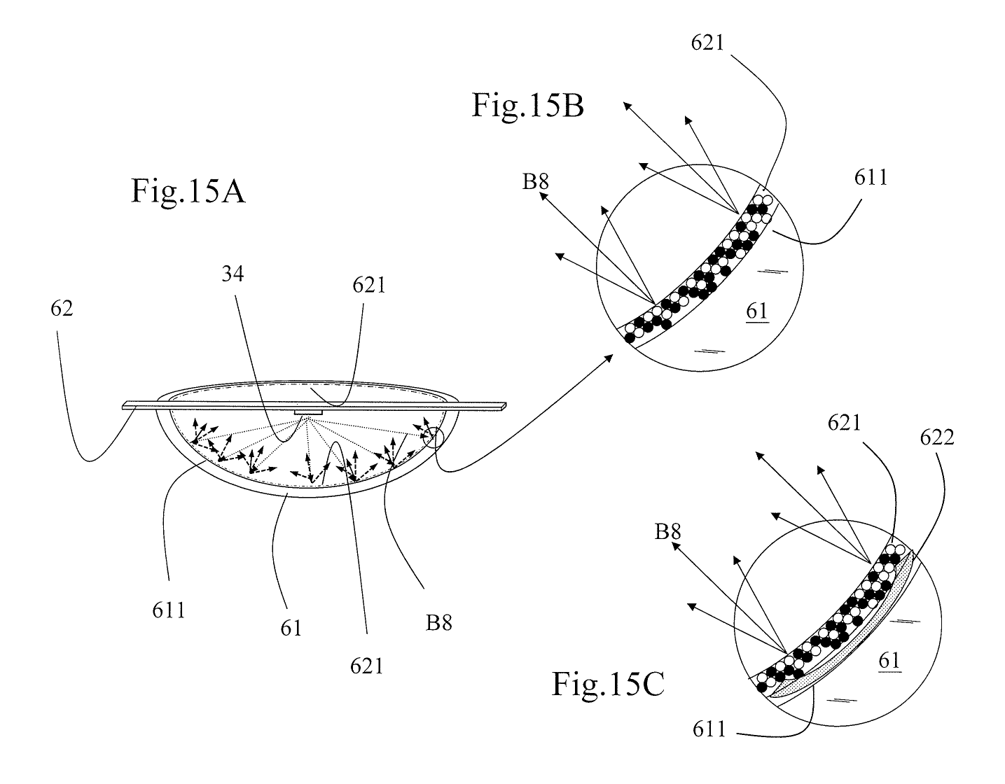

FIG. 15A˜15C is a section view of the fourth embodiment.

FIG. 15A is a section view of FIG. 14. FIG. 15A shows a light modification layer 621 is coated on the inner surface 611. The component and the function of the light modification layer 621 is the same as that in the previous embodiments described in this application. The light beam B8 impinges onto the inner surface 611 and then going out of the cup 61. FIG. 15B shows that the light modification layer 621 is a compact aggregation of a powder. The powder is one or a combination of ones selected from a group consisted of a yellow phosphor, a red phosphor, and green phosphor, and blue phosphor, and a reflective material. The reflective material is one or a combination of ones selected from the group consisted of BaSO4, MgO, TiO2, and zinc sulfide-barium pigment. FIG. 15C shows a modification embodiment to FIG. 15B, a reflection layer 622 is sandwiched in between the cup surface 611 and the light modification layer 621, to enhance the reflection of the light beams.

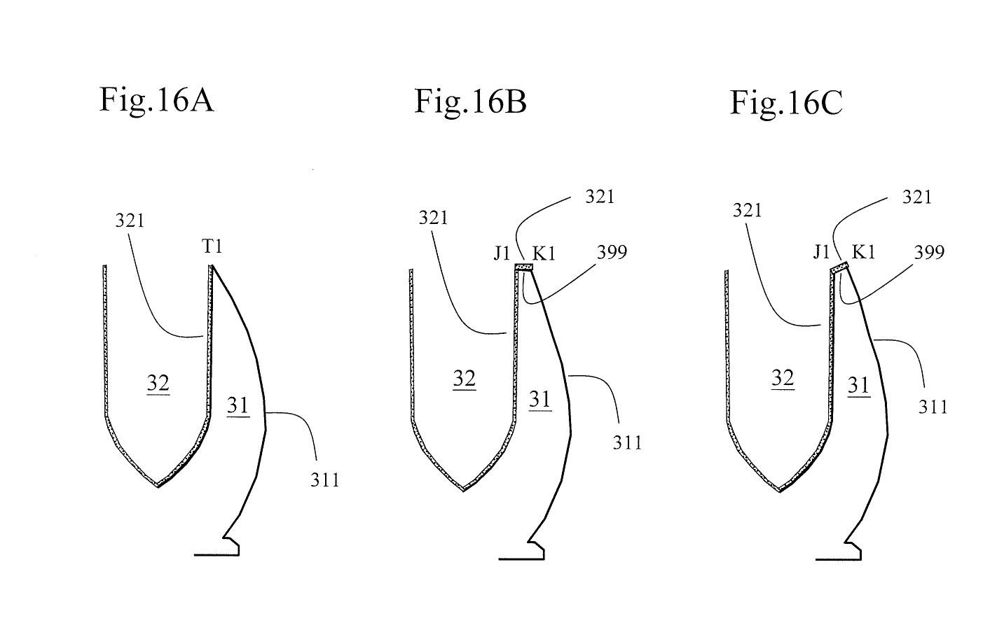

FIG. 16A˜16C a modification embodiment to the embodiment of FIG. 2B.

FIG. 16A is the same as the embodiment of FIG. 2B. However there is one disadvantage in this design. The tip T1 of the light guide 31 leaks light. Because a small bunch of light beams near the tip T1 exits directly without having opportunity to impinge onto any light modification layer 321.

FIG. 16B shows a flat top end is made to solve the light leakage problem at the tip of the light guide 31. A flat top 399 is made on the tip end of the light guide 31. A first angle J1 and a second angle K1 is formed, light modification layer 321 extends on a top surface of the flat top 399. Either the first angle J1 or the second angle K1 is made no less than 90 degree to ensure the light beam being modified by the light modification layer 321 before going out of the light guide 31, so that the efficiency of the light emission for a lamp is enhanced. FIG. 16B shows one example to meet the requirement, where the flat top 399 is made normal to the wall surface of the longitudinal hole 32. FIG. 16C is another embodiment to meet the requirement, where the flat top 399 is made normal to the peripheral surface 311 of the light guide 31.

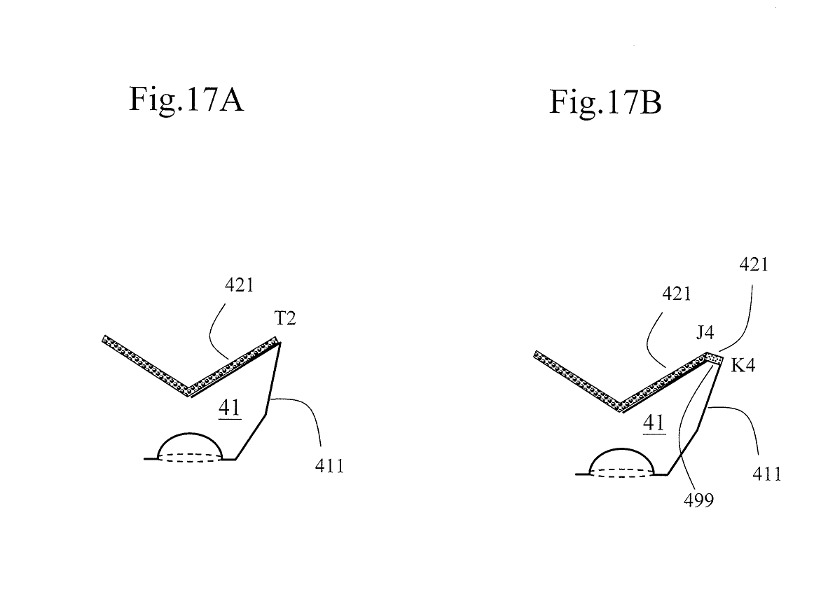

FIG. 17A˜17B a modification embodiment to the embodiment of FIG. 8A.

FIG. 17A is the same as the embodiment of FIG. 8A. However there is one disadvantage in this design. The tip T2 of the light guide 41 leaks light. Because a small bunch of light beams near the tip T2 exits directly without having opportunity to impinge onto any light modification layer 421. FIG. 17B shows a flat top end is made to solve the light leakage problem at the tip of the light guide 41. A flat top 499 is made on the tip end of the light guide 41. A first angle J4 and a second angle K4 is formed, light modification layer 421 extends on a top surface of the flat top 499. Either the first angle J4 or the second angle K4 is made no less than 90 degree to ensure the light beam being modified by the light modification layer 421 before going out of the light guide 41, so that the efficiency of the light emission for a lamp is enhanced.

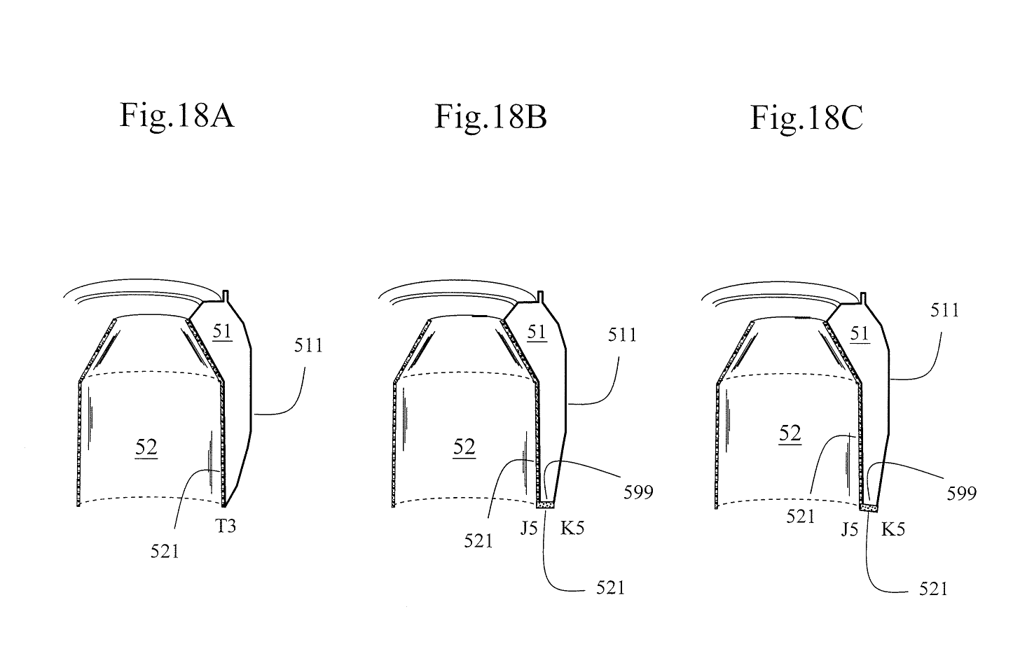

FIG. 18A˜18C a modification embodiment to the embodiment of FIG. 11A.

FIG. 18A is the same as the embodiment of FIG. 11B. However there is one disadvantage in this design. The bottom tip T3 of the light guide 51 leaks light. Because a small bunch of light beams near the tip T3 exits directly without having opportunity to impinge onto any light modification layer 521. FIG. 18B shows a flat bottom end is made to solve the light leakage problem at the tip of the light guide 51. A flat bottom 599 is made on the tip end of the light guide 51. A first angle J5 and a second angle K5 is formed, light modification layer 521 extends on a bottom surface of the flat bottom 599. Either the first angle J5 or the second angle K5 is made no less than 90 degree to ensure the light beam being modified by the light modification layer 521 before going out of the light guide 51, so that the efficiency of the light emission for a lamp is enhanced. FIG. 18B shows one example to meet the requirement, where the flat top 599 is made normal to the wall surface of the longitudinal hole 52. FIG. 18C is another embodiment to meet the requirement, where the flat bottom 599 is made normal to the peripheral surface 511 of the light guide 51.

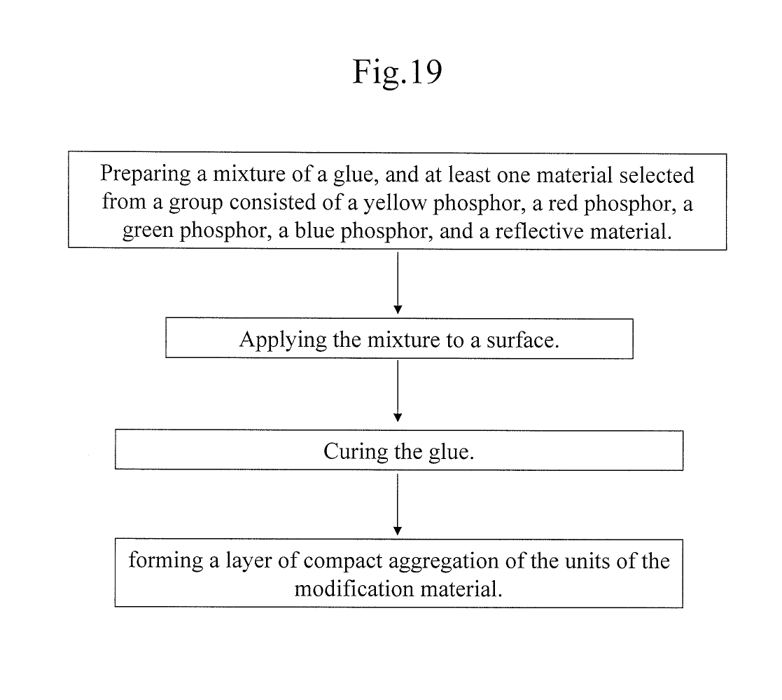

FIG. 19 is a method for preparation of the modification layer of the present invention.

A process for preparing a light modification layer on a surface according to the invention is described as follows:

preparing a mixture of a glue, and at least one material selected from a group consisted of a yellow phosphor, a red phosphor, a green phosphor, a blue phosphor, and a reflective material.

applying the mixture to a surface; and

curing the glue; and

forming a layer of compact aggregation of particles of the modification material.

While several embodiments have been described by way of example, it will be apparent to those skilled in the art that various modifications may be configured without departing from the spirit of the present invention. Such modifications are all within the scope of the present invention, as defined by the appended claims.

What is claimed is:

1. A lamp, comprising:
a light guide, having
a longitudinal hole, configured in a center of the light guide;
a total internal reflection surface, configured in an outer periphery of the light guide; and
a bottom cup recess, configured on a bottom of the light guide.

2. A lamp as claimed in claim 1, further comprising:
a light modification layer, configured on a wall surface of the longitudinal hole.

3. A lamp as claimed in claim 2, wherein the light modification layer is a compact aggregation of a powder.

4. A lamp as claimed in claim 3, wherein the powder is one or a combination of ones selected from a group consisted of a yellow phosphor, a red phosphor, and green phosphor, and blue phosphor, and a reflective material.

5. A lamp as claimed in claim 4, wherein the reflective material is one or a combination of ones selected from the group consisted of BaSO4, MgO, TiO2, and zinc sulfide-barium pigment.

6. A lamp as claimed in claim 2, further comprising:
a reflective layer, coated on an outer surface of the light modification layer.

7. A lamp as claimed in claim 6, further comprising:
a protection envelope, enclosing the light guide; and
a lamp base, configured on a bottom of the protection envelope.

8. A lamp as claimed in claim 1, further comprising
a flat top, configured on a top of the light guide, either angle J or angle K being made no less than 90 degree; wherein the angle J is an angle formed between the flat top and a wall surface of the longitudinal hole; and the angle K is an angle formed between the flat top and the total internal reflection surface.

9. A lamp, comprising:
a light guide, having
a conical recess having a first fan angle, configured on a tip end of the light guide;
a total internal reflection surface, configured in an outer periphery of the light guide; and
a bottom cup recess.

10. A lamp as claimed in claim 9, further comprising:
a light modification layer, configured on the surface of the conical recess.

11. A lamp as claimed in claim 10, wherein the light modification layer is a compact aggregation of a powder.

12. A lamp as claimed in claim 11, wherein the powder is a single one or a combination of ones selected from a group consisted of a yellow phosphor, a red phosphor, and green phosphor, and blue phosphor, and a reflective material.

13. A lamp as claimed in claim 12, wherein the reflective material is one or a combination of ones selected from the group consisted of BaSO4, MgO, TiO2, and zinc sulfide-barium pigment.

14. A lamp as claimed in claim 13, further comprising:
a reflective layer, coated on an outer surface of the light modification layer.

15. A lamp as claimed in claim 14, further comprising:
a reflecting cup, configured under the light guide for collecting and reflecting light beams emitted from the light guide.

16. A lamp as claimed in claim 9, further comprising:
a further conical recess, having a second fan angle smaller than the first fan angle, being made a total internal reflection surface, configured on a bottom of the first conical recess.

17. A lamp as claimed in claim 9, further comprising a flat top, configured on a tip end of the light guide, either angle J or angle K being made no less than 90 degree, wherein the angle J is an angle formed between the flat top and a wall surface of the longitudinal hole, the angle K is an angle formed between the flat top and the total internal reflection surface.

18. A lamp, comprising:
a light guide, having
a total internal reflection surface, configured in an outer periphery of the light guide;
a through channel, configured in a center of the light guide; wherein an upper portion of the channel being tapered out downward;
a plurality of top cup recess, configured evenly on a top of the light guide.

19. A lamp as claimed in claim 18, further comprising:
a light source, suspended on a center top of the top cup recess.

20. A lamp as claimed in claim 19, further comprising:
a ring-shape circuit board, configured on a top of the guide; and
the light source, configured on the ring-shape circuit board.

21. A lamp as claimed in claim 20, further comprising:
a reflective layer, coated on an outer surface of the light modification layer.

22. A lamp as claimed in claim 21, further comprising:
a protection envelope, enclosing the light guide; and
a lamp base, configured on a bottom of the protection envelope.

23. A lamp as claimed in claim 18, further comprising
a flat bottom, configured on a tip end of the light guide, either angle J or angle K being made no less than 90 degree, wherein the angle J is an angle formed between the flat top and a wall surface of the longitudinal hole, the angle K is an angle formed between the flat top and the total internal reflection surface.

24. An LED lamp, comprising:
a light modification layer, being a compact aggregation of a powder; wherein the powder is one or a combination of ones selected from a group consisted of a yellow phosphor, a red phosphor, and green phosphor, and blue phosphor, and a reflective material; and wherein the reflective material is one or a combination of ones selected from the group consisted of BaSO4, MgO, TiO2, and zinc sulfide-barium pigment.

25. A lamp as claimed in claim 24, further comprising:
a reflective layer, coated on an outer surface of the modification layer.

26. A cup lamp, comprising:
a cup, having an inner surface;
a light modification layer, coated on the inner surface; and
a light source, suspended on a center top of the cup.

27. A lamp as claimed in claim 26, wherein the light modification layer is a compact aggregation of a powder.

28. A lamp as claimed in claim 27, wherein the powder is one or a combination of ones selected from a group consisted of a yellow phosphor, a red phosphor, and green phosphor, and blue phosphor, and a reflective material.

29. A lamp as claimed in claim 27, wherein the reflective material is one or a combination of ones selected from the group consisted of BaSO4, MgO, TiO2, and zinc sulfide-barium pigment.

30. A cup lamp as claimed in claim 26, further comprising:
a latitudinal beam, mounted on top of the cup; wherein
the light source, configured on a bottom of the latitudinal beam.

31. A lamp as claimed in claim 30, further comprising:
a reflective layer, sandwiched in between the cup surface and the modification layer.

32. A process for preparing a light modification layer on a surface, comprising:
preparing a mixture of a glue, and at least one material selected from a group consisted of a yellow phosphor, a red phosphor, a green phosphor, a blue phosphor, and a reflective material.
applying the mixture to a surface; and
curing the glue; and
forming a layer of compact aggregation of particles of the modification material.
